(19) United States
(12) Patent Application Publication
(10) Pub. No.: US 2008/0028873 A1
(43) Pub. Date: Feb. 7, 2008

(54) Dispersed spray extraction particulate measurement method

(76) Inventors: Yi Zhao Yao, Singapore (SG); Hui Yan Hu, Singapore (SG); Garvin J. Stone, San Juan Batista, CA (US); Xiaozhou Ding, San Jose, CA (US); Gina Whitney, San Jose, CA (US); Shaoyong Liu, Singapore (SG); Kelvin K. Ang, Singapore (SG)

Correspondence Address: WAGNER, MURABITO & HAO LLP, Third Floor, Two North Market Street, San Jose, CA, 95113, US

(21) Appl. No.: 11/499,186

(22) Filed: Aug. 3, 2006

(51) Int. Cl. G01N 1/22

(52) U.S. Cl. 73/863.23

(57) ABSTRACT

A method for analyzing particulate contaminant on a part comprises: applying a pressurized liquid onto the part on which the particulate contaminant is to be analyzed, wherein applying the pressurized liquid provides a dispersed spray of pressurized liquid; collecting an applied volume of the pressurized liquid; providing the applied volume onto a filter apparatus; and providing the filter apparatus for performing analysis of the particulate contaminant.

### TECHNICAL FIELD

This invention relates generally to the field of materials analysis and quality control; and in particular a method of extracting particles from a part for analysis.

### BACKGROUND ART

The electronics industry continues to push for more performance in their products while making their products smaller. Miniaturization of components in these smaller products has required manufacturers to strive for cleaner parts. One exemplary area of the electronics industry that requires extremely clean components is the disk drive industry. Referring to Prior Art FIG. 1, the quest for storing larger amounts of data onto disk 120, which has been decreasing in size, has required slider 110, with its reading and writing (R/W) element 105, to fly closer to disk surface 125. For example, in disks with storage densities of 1 to 2 GB/in², the required flying height 150 is in the range of 35 to 50 nm. Storage density is currently approaching 100 GB/in². The required flying height must decrease commensurately to about 10 nm. For comparison, particles in tobacco smoke range from 10 nm to 10,000 nm.

Prior Art FIG. 2 is an exploded perspective view of a typical disk drive, known as a Hard Disk Drive (HDD) 200. It is obvious by this diagram that there are many parts, components and sub-assemblies, which have many surfaces. From hereon the use of the word “part” will also infer component and sub-assembly. The surfaces on these many parts must enter HDD 200 in a very clean condition or else particles on these surfaces could dislodge and become trapped between slider 110 and disk surface 125 during operation. A trapped particle between slider 110 and disk surface 125 will cause HDD 200 to fail in a number of ways depending upon the characteristics of the particle. The following particle characteristics are only given as examples and are not intended to be an all-inclusive or thorough presentation of particle characteristics and the failures they may cause.

If the size of a particle is in the range of fly height 150 and is soft enough to be deformed, it can smear itself on the disk surface 125 or slider 110 and cause slider 110 to fly excessively high and inhibit reading or writing of data. If the size of a particle is in the range of fly height 150, it can cause data on disk surface 125 to be erased. It is also possible for such a particle to become embedded in RJW element 105 and render it partially or totally inoperative. Catastrophic failure of HDD 200 can occur if a particle is slightly larger than fly height 150. Since slider 110 flies at an angle, the particle can become trapped between slider 110 and disk surface 125 and thus alter the flying characteristics of slider 110. Catastrophic failure can take on several forms with a trapped particle between slider 110 and disk surface 125. The particle or slider 110 can scratch disk surface 125. Depending on the severity of a scratch, disk surface 125 can be rendered useless. Scratches can propagate further disk damage. An initially scratch can cause slider 110 to fly erratically and damage more of the disk surface. Scratches generate more particles and other slider-disk interfaces can become contaminated with particles and also fail. In these scenarios of catastrophic failure, data can be lost and the customers' information may not be retrievable. In general, any catastrophic failure as described above is known as a “head crash.”

Along with parts being free of particles as they enter HDD 200, it is equally important that particles of the parent material, from which a part is made, are not left on the part. Examples of these particles are burrs and stringers. Burrs and stringers are typically a byproduct of a stamping or shearing process in which the mating metal parts of the stamp or shear do not completely remove all the excess material for making the part. A piece of material, usually small and thin in comparison to the part, is left partially attached to the part. This small thin piece of material is known as a burr for a metal part and a stringer for a plastic part. It is of great concern that a burr or stringer can become dislodged inside HDD 200 and cause damage inside HDD 200.

The previous examples of particles being trapped between slider 110 and disk surface 125 are not the only concerns for damage and failure due to particles in HDD 200. Those schooled in the art of disk drives, materials analysis, or quality control will appreciate that other modes of damage and failure due to particulates can occur.

The challenge of assuring clean parts has always existed in the electronics industry. As the electronics industry has evolved, so have the methods of cleaning parts. The methods for measuring cleanliness have also evolved.

The current method for analyzing cleanliness, which is widely used in the disk drive industry, is a method known as ultrasonic extraction. International Disk Drive Equipment and Materials Association (IDEMA) Standard on Microcontamination, Document No. M9-98, has standardized the parameters for ultrasonic extraction, which has been in use for many years. In brief ultrasonic extraction involves submersing a part into a liquid solution of purified water, such as deionized (DI) water, and a wetting agent, such as a surfactant or detergent. Ultrasonic energy is applied to the liquid containing the part. The liquid is collected for analysis of its particulate content.

There are several methods for analyzing the liquid for particulate that may have come off the part. It is not the intention of this presentation of Background Art to include all analysis methods. Two widely used methods are described briefly here. The first method involves passing light through some of the liquid that was used for the ultrasonic extraction and measuring the amount of light that is blocked by the particles suspended in the liquid. The second method involves filtering some of the liquid used in the ultrasonic extraction. The filtering condenses the particles that are suspended in the liquid onto a filter media, such as a porous membrane. The filter with its condensed particles is analyzed with a Scanning Electron Microscope and Energy Dispersive X-ray (SEM/EDX).

A method of spray extraction is also standardized in IDEMA Standard on Microcontamination, Document No. M9-98. It involves pressurizing water, passing it through a needle jet nozzle, and directing the resulting thin jet of water at the part to be extracted. The water is collected and subjected to analysis as previously described.

A major undesirable effect of ultrasonic extraction is that the part can be eroded by the ultrasonic energy going into the part. Ultrasonic energy removes particles from a part by creating small bubbles that implode on the surface of the part. The locations at which these bubbles form are the locations on the part were a particle (or other contaminant) resides. Bubbles however also form at the locations of small irregularities on the part, such as inherent surface roughness or machining marks. The part will erode at these locations as bubbles form and implode. Through experimentation, it has been found that the amount of eroded material from a part can be much greater than that of the particles being extracted. Ultrasonic frequency and energy levels can be chosen to minimize part erosion, but the trade off can be insufficient removal of particulate contamination.

There are disadvantages to spray extraction with a thin jet of water. Several passes with the thin jet must be made to adequately cover a surface of a part. Features on the part can cause the thin jet to be deflected unpredictably resulting in possible loss of water for analysis.

### SUMMARY OF THE INVENTION

A method for analyzing particulate contaminant on a part comprises: applying a pressurized liquid onto the part on which the particulate contaminant is to be analyzed, wherein applying the pressurized liquid provides a dispersed spray of pressurized liquid; collecting an applied volume of the pressurized liquid; providing the applied volume onto a filter apparatus; and providing the filter apparatus for performing analysis of the particulate contaminant.

### BRIEF DESCRIPTION OF THE DRAWINGS

The accompanying drawings, which are incorporated in and form a part of this specification, illustrate embodiments of the invention and, together with the description, serve to explain the principles of the invention:

Prior Art FIG. 1 is a side view of a Head Gimbal Assembly (HGA) and its slider flying over a disk surface.

Prior Art FIG. 2 is an exploded perspective view of a Hard Disk Drive (HDD).

FIG. 3 is a schematic diagram of a dispersed spray extraction apparatus in accordance with one embodiment of the present invention.

FIG. 4 a schematic diagram of a dispersed spray extraction apparatus having a filtering system in accordance with another embodiment of the present invention.

FIG. 5 is a flow chart illustrating steps of a method of operation for a dispersed spray extraction apparatus in accordance with one embodiment of the present invention.

FIG. 6 is a flow chart illustrating steps of a method of operation for a dispersed spray extraction apparatus in accordance with another embodiment of the present invention.

### DETAILED DESCRIPTION

It is the goal of the embodied invention to address the challenges presented by the cited prior art while achieving easy and accurate analysis of particulate on parts that may cause damage to a higher assembly during operation.

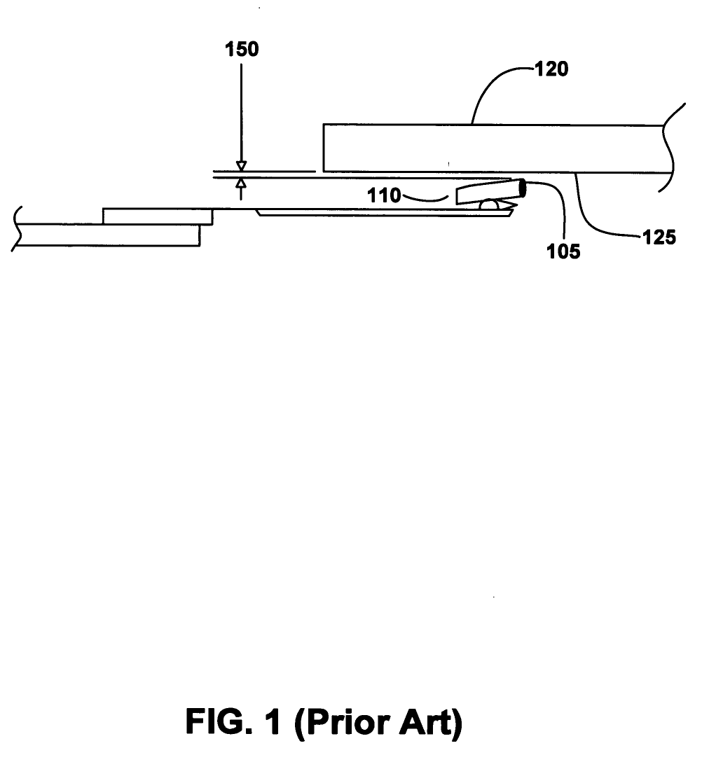

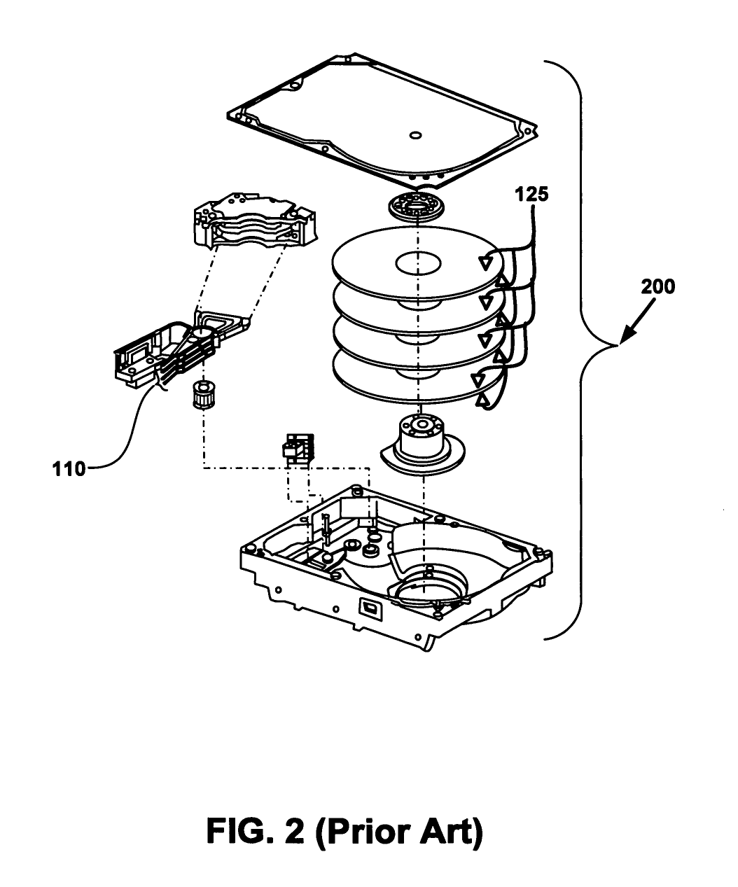

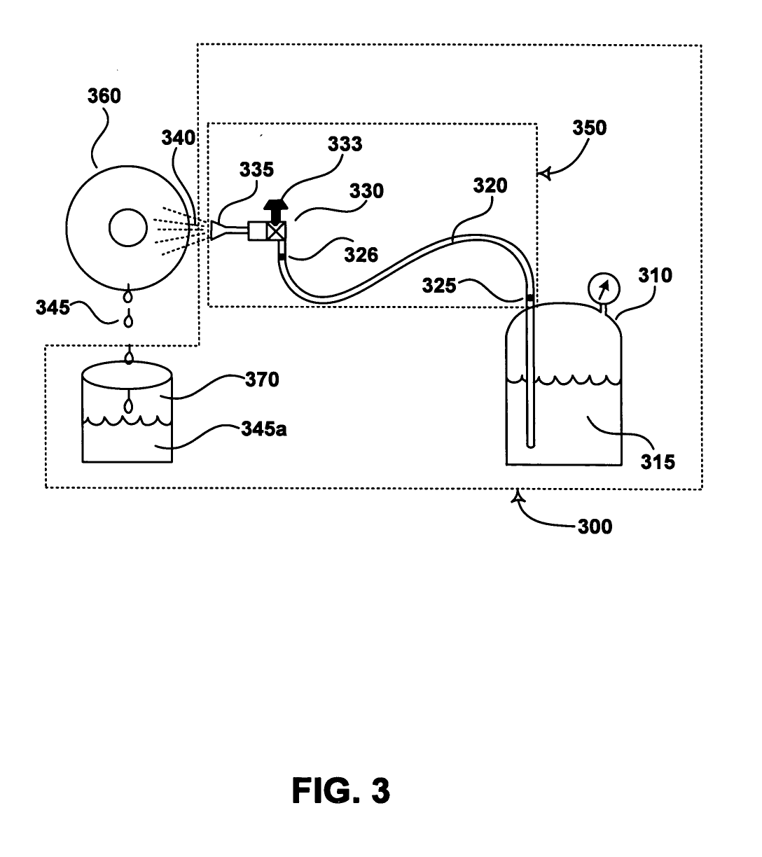

With reference now to FIG. 3, a side view is shown of the dispersed spray extraction apparatus 300 of the present invention. The following discussion will begin with a description of the physical structure of the present invention. This discussion will then be followed with a description of the operation of the present invention.

### Physical Description

With respect to the physical structure of the present invention, dispersed spray extraction apparatus 300 of the present embodiment has a pressurized liquid 315 that is contained under pressure in vessel 310. Delivery system 350 consists of a hose 320, which has one end 325 connected to vessel 310, and other end 326 connected to nozzle 330. Nozzle 330 has an entrance end that coincides with hose end 326. At the exit end on nozzle 330 is orifice 335. Orifice 335 is constricted such as to produce dispersed spray 340. In between entrance end 326 and orifice 335 is valve device 333. Included also in dispersed spray extraction apparatus 300 is collection hardware 370. An exemplary delivery system 350 is a spray system sold by Spray System Co. comprising: Unijet Fan Nozzle, TP 250017-SS +1/4 TT-SS; Gas Line Filter Holder, XX 4002500; Spray Gun, AA 23H-SS-12495; and 25 mm Gas Line Filter, HAWP 02500—0.45 μm. An exemplary vessel 310 is Liquid Pressure Tank Assembly, 36455-5-SS304S also sold by Spray System Co.

Pressurized liquid 315 is kept under pressure in vessel 310. In one embodiment vessel 310 is a vessel that can be pressurized by an external pressure source, such as a pump, house air supply, or house nitrogen. Delivery system 340 applies pressurized liquid 315 as dispersed spray 340. In another embodiment vessel 310 is an aerosol can containing a pre-packaged pressurized liquid 315 and a self-contained delivery system 350. This invention is not limited by the means that pressurized liquid 315 is contained and delivered in dispersed spray 340. One schooled in the art will recognize that there are various means for containing pressurized liquid 315 and delivering pressurized liquid 315 as dispersed spray 340.

In one embodiment, dispersed spray 340 is applied to part 360 in a routine manner that assures consistency of coverage of disperse spray 340 on part 360. The routine is predetermined to assure consistent extraction from part to part. As an example, the exemplary disk (part 360) may be scanned from side to side at a defined scan rate and pattern or rotated at a defined rotational speed to assure repeatable and consistent coverage of dispersed spray 340 on part 360. Conversely, in another embodiment, a singular discrete location of interest can be extracted for particulate analysis by applying dispersed spray 340 only at the discrete location of interest.

Pressurized liquid 315 is a solution of purified water and a wetting agent. A wetting agent is a water-soluble detergent, or surfactant, that when added to water, lowers the surface tension of water and enhances the water's ability to cover and cling to a surface. A wetting agent added to water will enhance the water's ability to remove particles from a surface. Pressurized liquid 315 is applied to part 360 as a dispersed spray 340. Dispersed spray 340 impinges on the surface of part 360 and dislodges particles from part 360. Volume 345a of run-off 345 from dispersed spray 340, and the entrained particles, are collected into collection hardware 370. Collection hardware 370, as shown in the embodiment depicted in FIG. 3, consists of an open container, such as a beaker, suitable for collecting liquid.

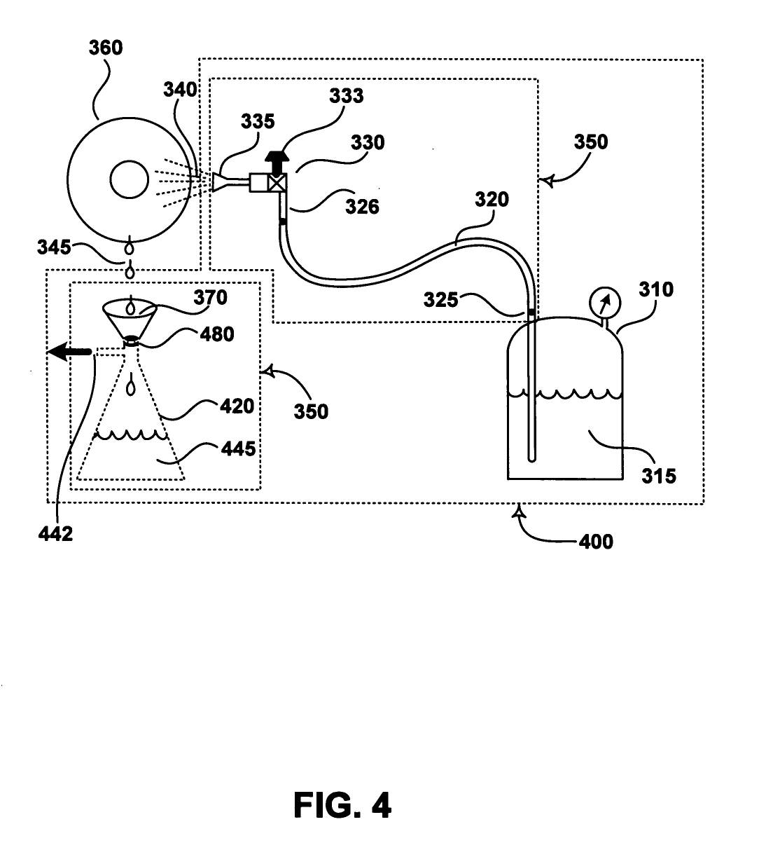

The embodiment depicted in FIG. 4 demonstrates that collection hardware 370 can be attached to filter apparatus 480. Dispersed spray extraction apparatus 400 incorporates filtering system 450. Filtering system 450 includes filter apparatus 480, which consists of a filtration membrane that is much thinner than its diameter. Many filtration membrane manufacturers exist in the industry. An example of a filtration membrane that is appropriate for use in this invention is a Track-Etch Membrane made from polycarbonate or polyester. An exemplary filtering system 450 operates by using container 420, which is conducive to a low-pressure outlet 442, whereby run-off 345 is collected by collection hardware 370 and sucked through filter apparatus 480. Part 360 is over filter apparatus 480. Filter apparatus 480 is the bottom of collection hardware 370. The entrained particles in run-off 345 are condensed onto filter apparatus 480. Liquid 445 that passes through filter apparatus 480 is devoid of particles that have been condensed for analysis on filter apparatus 480.

The embodiment depicted in FIG. 3 requires that volume 345a be processed through filtering system 450 so that particulate from volume 345a can be condensed onto filter apparatus 480. Processing volume 345a through filtering system 450 comprises: introducing volume 345a to collection hardware 370 of filtering system 450; applying low pressure to outlet 442 of container 420; sucking volume 345a through filter apparatus 480; and condensing particulate onto filter apparatus 480.

Filter apparatus 480 is available for analyzing the particulate that have been condensed on to it. Various analyses can be performed. Counting of the amount of particulate can be performed effectively by using an SEM. The morphology analysis of the particulate that SEM makes available can also give insight into the origin of the particulate. More detailed analysis of the particulates' origin can be gained from EDX analysis.

### In Operation

The following discussion sets forth in detail the operation of the present invention. As shown in schematic diagram FIG. 3, in the present invention, dispersed spray extraction apparatus 300 is used to extract particulate contaminants from a part for analysis. FIG. 3 shows part 360, a computer disk, being extracted for particulate contaminants. The computer disk is only exemplary of a part. Any part can be subjected to extraction apparatus 300. Schematic diagram FIG. 4 shows an alternate embodiment wherein dispersed spray extraction apparatus 400 includes filtering system 450.

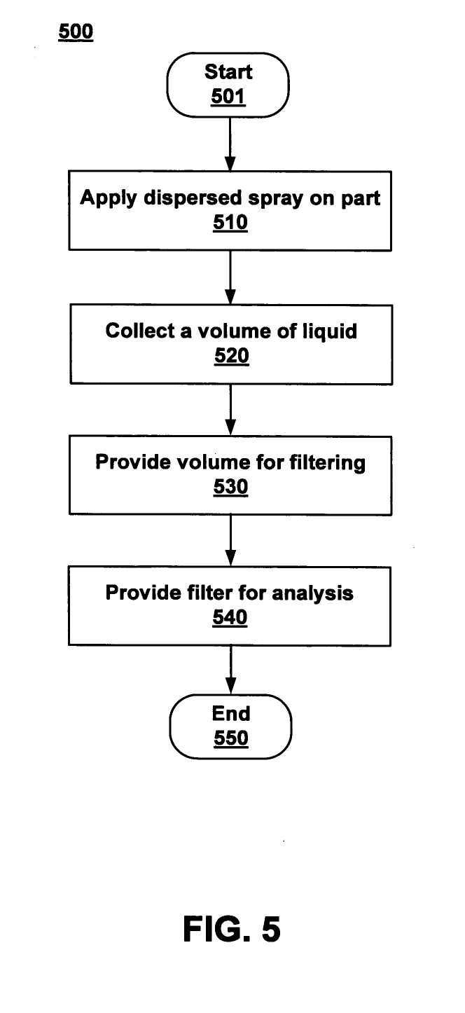

FIG. 5 is a flow chart of a process 500 in which particular steps are performed in accordance with an embodiment of the present invention for extracting particulate from a part for analysis using dispersed spray extraction. FIG. 5 includes processes of the present invention, which in one embodiment, are carried out by processors, electrical components and assembly mechanisms under the control of computer readable and computer executable instructions. The computer readable and computer executable instructions reside, for example, in data storage features such as a computer usable volatile memory and/or a computer usable non-volatile memory and/or a data storage device. However, the computer readable and computer executable instructions may reside in any type of computer readable medium. Although specific steps are disclosed in process 500, such steps are exemplary. That is, the present invention is well suited to performing various other steps or variations of the steps recited in FIG. 5. Within the present embodiment, it should be appreciated that the steps of process 500 may be performed by software, by hardware, by an assembly mechanism, through human interaction, or by any combination of software, hardware, assembly mechanism and human interaction.

In step 501 of process 500, part 360 enters the process for application to dispersed spray extraction apparatus 300 and 400 as shown in FIGS. 3 and 4. Referring to FIGS. 3 and 4, part 360 is introduced to dispersed spray 340 in a manner that does not obstruct dispersed spray 340 from impinging upon the surface of part 360. Part 360 is positioned in dispersed spray extraction apparatus 300 and 400 in a manner that allows run-off 345 to be collected in collection hardware 370.

In step 510 of process 500, dispersed spray 340 is applied onto part 360. Referring to FIGS. 3 and 4, delivery system 350 receives pressurized liquid 315 from vessel 310 and applies dispersed spray 340 onto part 360 through nozzle 330.

In step 520 of process 500, a volume 345a (or run-off 345) is collected after being applied as dispersed spray 340 onto part 360. FIG. 3 shows collection hardware 370 as an open container such as a beaker. FIG. 4 shows collection hardware 370 as an open container with filter apparatus 480 comprising the bottom of collection hardware 370.

In step 530 of process 500, a collected volume 345a (or run-off 345) is provided for filtering. In reference to FIG. 3, colleted volume 345a is poured into filtering system 450 as shown in FIG. 4. In reference to FIG. 4, run-off 345 enters directly into filtering system 450.

In step 540 of process 500, filter apparatus 480 is provided for analysis. Whether collected volume 345a (FIG. 3) is poured into filtering system 450, or run-off 345 enters directly onto filtering system 450 (FIG. 4), filter apparatus 480 has condensed extracted particulate from part 360 that can be analyzed.

In step 550 of process 500, the process ends. The end result of process 500 is providing extracted particles on filter apparatus 480 for analysis.

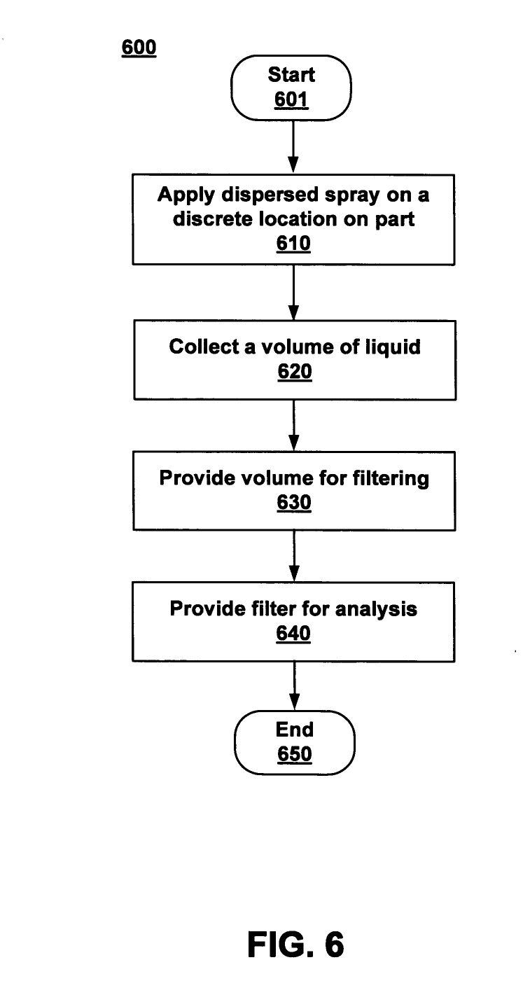

FIG. 6 is a flow chart of a process 600 in which particular steps are performed in accordance with an embodiment of the present invention for extracting particulate from a part for analysis using dispersed spray extraction. FIG. 6 includes processes of the present invention, which in one embodiment, are carried out by processors, electrical components and assembly mechanisms under the control of computer readable and computer executable instructions. The computer readable and computer executable instructions reside, for example, in data storage features such as a computer usable volatile memory and/or a computer usable non-volatile memory and/or a data storage device. However, the computer readable and computer executable instructions may reside in any type of computer readable medium. Although specific steps are disclosed in process 600, such steps are exemplary. That is, the present invention is well suited to performing various other steps or variations of the steps recited in FIG. 6. Within the present embodiment, it should be appreciated that the steps of process 600 may be performed by software, by hardware, by an assembly mechanism, through human interaction, or by any combination of software, hardware, assembly mechanism and human interaction.

In step 601 of process 600, part 360 enters the process with a discrete location for application to dispersed spray extraction apparatus 300 and 400 as shown in FIGS. 3 and 4. Referring to FIGS. 3 and 4, part 360 is introduced to dispersed spray 340 in a manner that does not obstruct dispersed spray 340 from impinging upon the surface of part 360. Part 360 is positioned in dispersed spray extraction apparatus 300 and 400 in a manner that allows run-off 345 to be collected in collection hardware 370.

In step 610 of process 600, dispersed spray 340 is applied onto part 360. Referring to FIGS. 3 and 4, delivery system 350 receives pressurized liquid 315 from vessel 310 and applies dispersed spray 340 onto part 360 through nozzle 330.

In step 620 of process 600, a volume 345a (or run-off 345) is collected after being applied as dispersed spray 340 onto part 360. FIG. 3 shows collection hardware 370 as an open container such as a beaker. FIG. 4 shows collection hardware 370 as an open container with filter apparatus 480 comprising the bottom of collection hardware 370.

In step 630 of process 600, a collected volume 345a (or run-off 345) is provided for filtering. In reference to FIG. 3, colleted volume 345a is poured into filtering system 450 as shown in FIG. 4. In reference to FIG. 4, run-off 345 enters directly into filtering system 450.

In step 640 of process 600, filter apparatus 480 is provided for analysis. Whether collected volume 345a (FIG. 3) is poured into filtering system 450, or run-off 345 enters directly onto filtering system 450 (FIG. 4), filter apparatus 480 has condensed extracted particulate from part 360 that can be analyzed.

In step 650 of process 600, the process ends. The end result of process 600 is providing extracted particles on filter apparatus 480 from a discrete location on part 360 for analysis.

Advantageously, the present invention, in the various presented embodiments allows for the spray extraction of a part without concern for losing sprayed liquid being deflected and lost due to part features. A dispersed spray also presents increased surface area of the part for extraction.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A method for analyzing particulate contaminant on a part, said method comprising:
applying a pressurized liquid onto said part on which said particulate contaminant is to be analyzed, wherein said applying provides a dispersed spray of said pressurized liquid;
collecting an applied volume of said pressurized liquid;
providing said applied volume to a filter apparatus; and
providing said filter apparatus for performing analysis of said particulate contaminant.

2. The method as recited in claim 1 wherein said pressurized liquid comprises pressurizing a solution of purified water and a wetting agent.

3. The method as recited in claim 1 wherein said applying of said pressurized liquid comprises applying said pressurized liquid using a constricted orifice.

4. The method as recited in claim 1 wherein said applying of said pressurized liquid comprises applying said pressurized liquid in a predetermined routine.

5. The method as recited in claim 1 wherein said collecting of said applied volume comprises applying said pressurized liquid onto said part over an open container.

6. The method as recited in claim 1 wherein said collecting of said applied volume comprises applying said pressurized liquid onto said part over said filter apparatus.

7. The method as recited in claim 1 wherein said analysis of said particulate contaminants comprises:
using a scanning electron microscope to analyze said particulate contaminant.

8. The method as recited in claim 1 wherein said analysis of said particulate contaminants comprises:
using energy dispersive x-ray to analyze said particulate contaminant.

9. An apparatus for extracting particulate contaminant from a part for the purpose of analyzing said particulate contaminant, said apparatus comprising:
a vessel of pressurized liquid;
a delivery system wherein said pressurized liquid is applied as a dispersed spray; and
a collection hardware wherein a volume of liquid of said pressurized liquid is collected after being applied to said part.

10. The apparatus of claim 9 further comprising a filter apparatus wherein said particulate contaminant from said volume of liquid is condensed onto a filtration membrane.

11. The apparatus of claim 9 wherein said vessel is a rechargeable pressurized container.

12. The apparatus of claim 9 wherein said vessel is a non-rechargeable pressurized aerosol can wherein said delivery system is integral to said aerosol can.

13. The apparatus of claim 9 wherein said delivery system comprises:
a first distal end of a hose connected to said vessel; and
a second distal end of said hose connected to an entrance end of a valve device, wherein said valve device controls the flow of said pressurized liquid; and
an orifice connected to an exit end of said valve device, wherein said orifice applies said pressurized liquid onto said part.

14. The apparatus of claim 9 wherein said collection hardware comprises an open vessel suited for catching said pressurized liquid falling from said part after said pressurized liquid is applied to said part.

15. The apparatus of claim 9 wherein said collection hardware is coupled to said filter apparatus.

16. A method for condensing particulate contaminant from a discrete location on a part for performing analysis of said particulate contaminant, said method comprising;
applying a pressurized liquid onto said discrete location on which said particulate contaminant are to be analyzed, wherein said applying provides a dispersed spray of said pressurized liquid;
collecting an applied volume of said pressurized liquid;
providing said applied volume to a filter apparatus; and
providing said filter apparatus for performing analysis of said particulate contaminant obtained from said discrete location of said part.

17. The method as recited in claim 15 wherein said pressurized liquid comprises pressurizing a solution of purified water and a wetting agent.

18. The method as recited in claim 15 wherein said applying of said pressurized liquid comprises applying said pressurized liquid using a constricted orifice.

19. The method as recited in claim 15 wherein said collecting of said applied volume comprises applying said pressurized liquid onto said part over an open container.

20. The method as recited in claim 15 wherein said collecting of said applied volume comprises applying said pressurized liquid onto said part over said filter apparatus.

21. The method as recited in claim 15 wherein said analyses of said particulate contaminant comprises using:
a scanning electron microscope to analyze said particulate contaminant.

22. The method as recited in claim 15 wherein said analyses of said particulate contaminant comprises using:
energy dispersive x-ray to analyze said particulate contaminant.
